(19) United States
(12) Patent Application Publication
(10) Pub. No.: US 2026/0336067 A1
(43) Pub. Date: Oct. 29, 2026

(54) HYBRID MAGNETIC-VACUUM FIXTURE AND AUTOMATED MANUFACTURING SYSTEM USING THE SAME

(71) Applicant: EARTH-CHAIN ENTERPRISE CO., LTD., Taichung City (TW)

(72) Inventor: Mu-Chuan WANG, Taichung City (TW)

(21) Appl. No.: 19/233,662

(22) Filed: Jun. 10, 2025

(30) Foreign Application Priority Data
Apr. 24, 2025 (TW) 114115485

(51) Int. Cl. B25B 11/00

(52) U.S. Cl. CPC B25B 11/002; B25B 11/005

(57) ABSTRACT

The present invention provides a hybrid magnetic-vacuum fixture, comprising: a workpiece mounting platform including a clamping surface; a modular vacuum assembly assembled at a predetermined location on the workpiece mounting platform, wherein the modular vacuum assembly includes a plurality of suction nozzles formed on the clamping surface, such that the plurality of suction nozzles and the clamping surface collectively define a working surface for positioning an object, thereby enabling selective control over the adsorption or release of the object; and an electromagnetic clamping assembly assembled at another predetermined location on the workpiece mounting platform, wherein the electromagnetic clamping assembly is operatively coupled to an electrification device for generating magnetic attraction at the clamping surface. Through this integrated design, the fixture supports multiple operational modes for clamping either metal or non-metal objects, thereby providing enhanced functional versatility and practical industrial value.

### FIELD OF INVENTION

The present invention relates to a fixture, and more particularly to a hybrid magnetic-vacuum fixture that is suitable for securely retaining various types of workpieces.

### BACKGROUND OF THE INVENTION

Conventional machine tools, such as lathes, milling machines, grinders, and machining centers, are commonly equipped with a fixture for positioning and securing a workpiece during processing. While traditional fixtures use mechanical clamping mechanisms to immobilize a workpiece, alternative fixture types using magnetic attraction are also commercially available. However, fixtures that rely on magnetic force are only effective for securing ferromagnetic metal workpieces. This inherent limitation significantly restricts their applicability and prevents them from accommodating the increasingly diverse operational demands encountered in modern manufacturing environments. As a result, conventional fixtures lack the flexibility and adaptability required for broader industrial use.

Given the aforementioned limitations associated with existing fixture designs, there is a substantial need for the development of a novel fixture architecture that can integrate multiple clamping modalities. Such a fixture would be of considerable value to manufacturers and represents a critical direction for technological advancement in the field of machine tool accessories and automated systems.

### SUMMARY OF THE INVENTION

To address the foregoing limitations, the present invention provides a hybrid magnetic-vacuum fixture comprising: a workpiece mounting platform, wherein the workpiece mounting platform includes a clamping surface; a modular vacuum assembly assembled at a predetermined location on the workpiece mounting platform, wherein the modular vacuum assembly includes a plurality of suction nozzles formed on the clamping surface, such that the plurality of suction nozzles and the clamping surface collectively define a working surface for positioning an object, thereby enabling selective control over the adsorption or release of the object; and an electromagnetic clamping assembly assembled at a different predetermined location on the workpiece mounting platform, wherein the electromagnetic clamping assembly is operatively coupled to an electrification device configured to generate magnetic attraction at the clamping surface.

The hybrid magnetic-vacuum fixture is particularly suitable for integration within an automated manufacturing system. In operation, the electromagnetic clamping assembly generates magnetic attraction on the clamping surface to adsorb and retain a metal workpiece. Alternatively, the plurality of suction nozzles of the modular vacuum assembly generates vacuum suction to adsorb and retain a non-metal workpiece. The modular vacuum assembly may also be employed to adsorb a metal workpiece if required. Accordingly, the hybrid magnetic-vacuum fixture is capable of operating in multiple functional modes to accommodate a broad range of workpiece materials and clamping requirements.

### BRIEF DESCRIPTION OF THE DRAWINGS

FIG. 1 is an assembled perspective view of a preferred embodiment of the present invention.

FIG. 2 is an exploded perspective view of the preferred embodiment.

FIG. 3 is a cross-sectional view of the assembled state of the preferred embodiment.

FIG. 4 is a cross-sectional view showing distribution manifolds and flow ports of the preferred embodiment (Part 1).

FIG. 5 is a cross-sectional view showing distribution manifolds and flow ports of the preferred embodiment (Part 2).

### DETAILED DESCRIPTION OF THE PREFERRED EMBODIMENTS

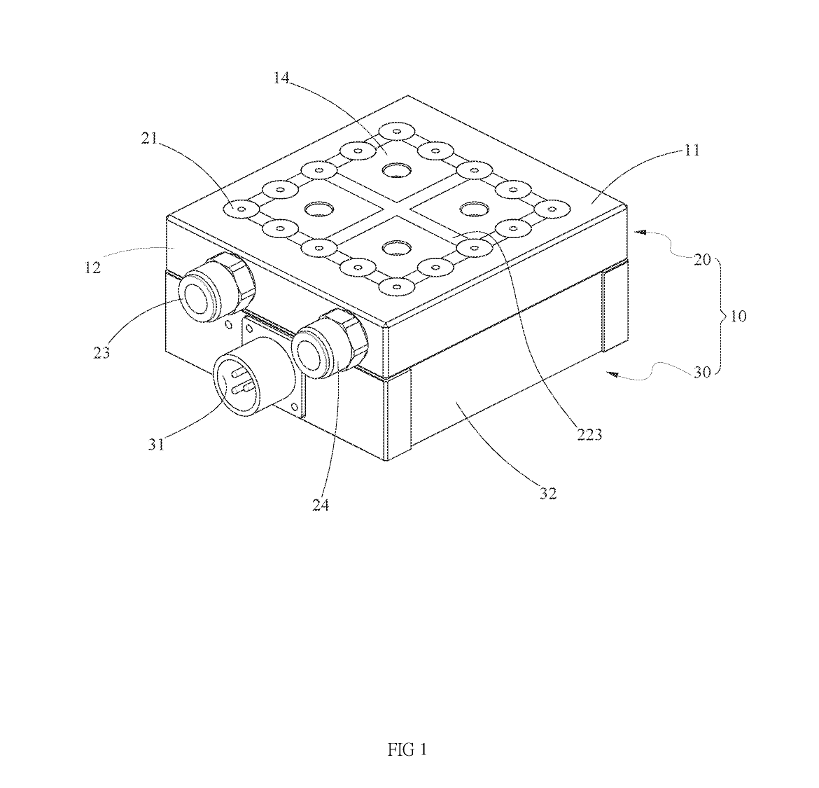

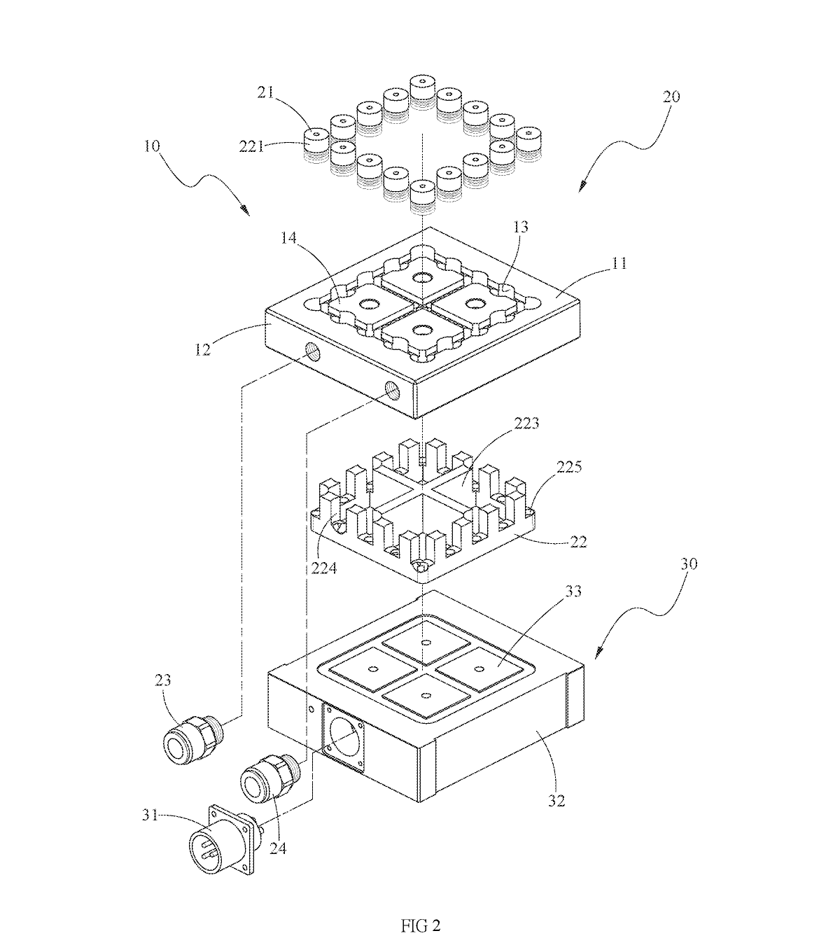

Referring to FIGS. 1 and 2, a preferred embodiment of a hybrid magnetic-vacuum fixture in accordance with the present invention is illustrated. It should be understood that the embodiments described herein are provided solely for illustrative purposes and are not intended to limit the scope of the present invention.

The hybrid magnetic-vacuum fixture comprises a workpiece mounting platform 10, a modular vacuum assembly 20, and an electromagnetic clamping assembly 30. The workpiece mounting platform 10 may be configured as either a circular block or a rectangular block. In the illustrated embodiment, the workpiece mounting platform 10 is a rectangular block comprising a clamping surface 11, a perimeter wall 12, a cross-shaped recess 13, and a plurality of magnetic flux zones 14. The clamping surface 11 is defined on one major surface of the workpiece mounting platform 10. The perimeter wall 12 surrounds the clamping surface 11, and the cross-shaped recess 13 is formed as a frame-shaped groove recessed into the clamping surface 11. In the present embodiment, the cross-shaped recess 13 is configured as a cross-shaped groove extending through the workpiece mounting platform 10. The plurality of magnetic flux zones 14 are disposed within the cross-shaped recess 13. In this embodiment, four magnetic flux zones 14 are provided, each located within a different segment of the cross-shaped recess 13. During operation, adjacent pairs of the magnetic flux zones 14 cooperate to generate magnetic flux for adsorbing or releasing a workpiece (not shown) positioned on the clamping surface 11.

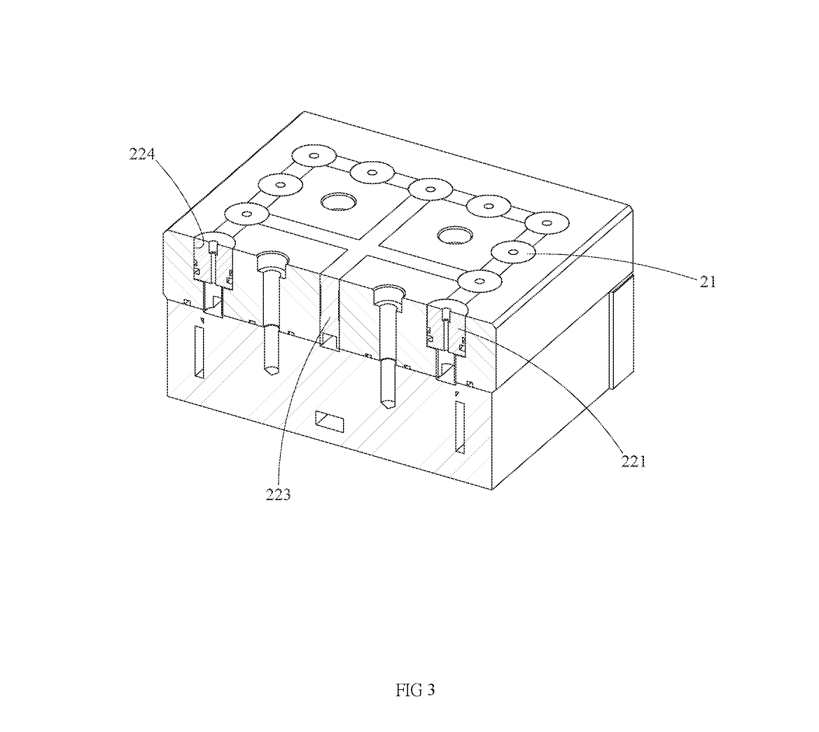

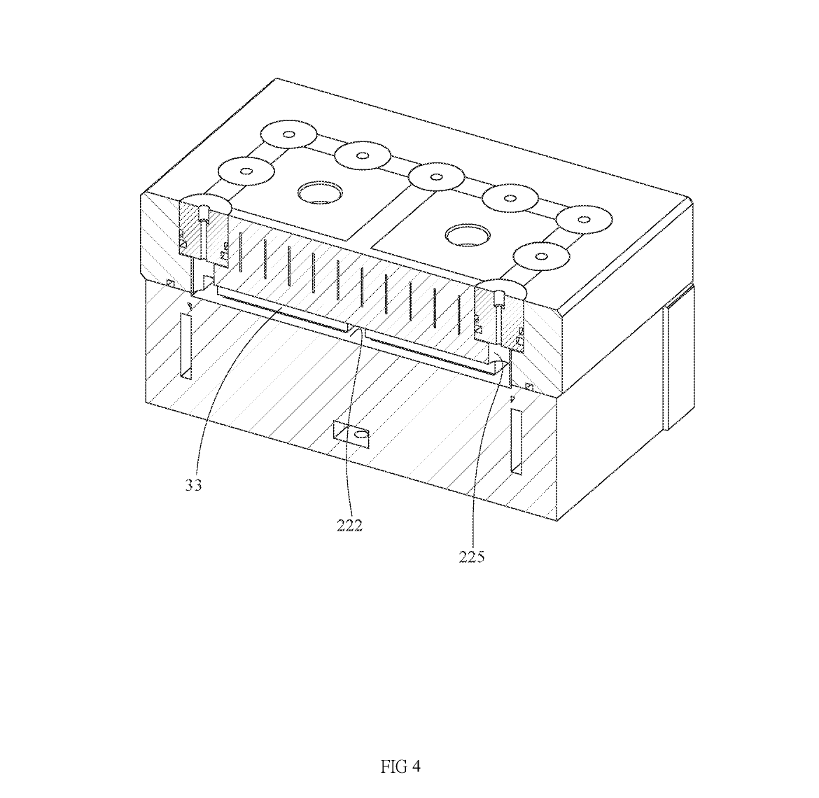

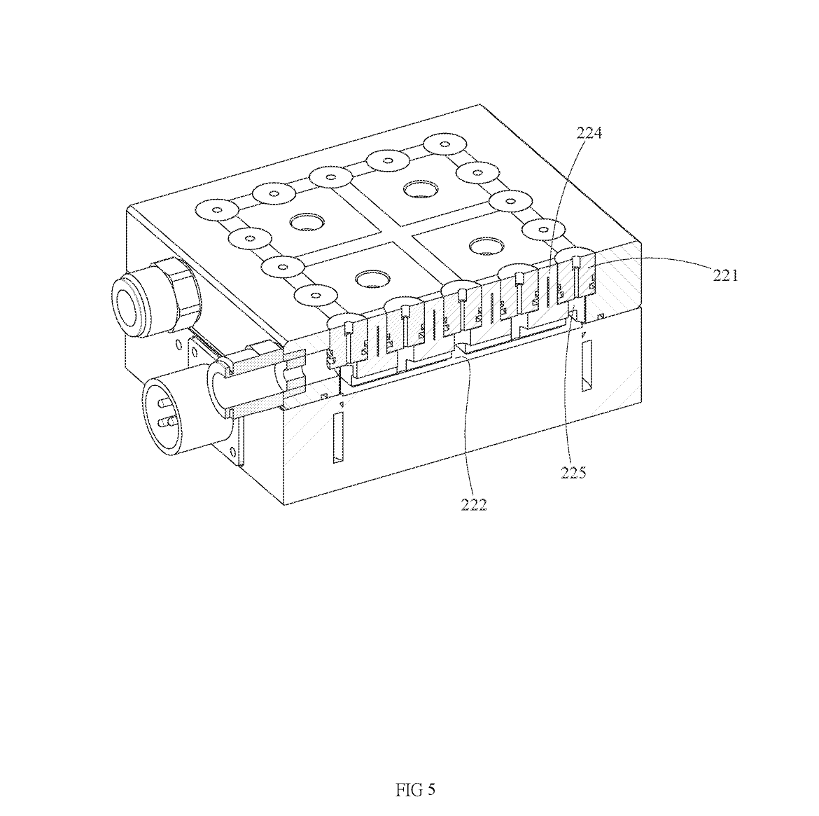

Referring further to FIGS. 3-5, the modular vacuum assembly 20 is dimensioned and shaped to correspond to the cross-shaped recess 13 and is configured as a rectangular frame received within the cross-shaped recess 13. The modular vacuum assembly 20 comprises a plurality of suction nozzles 21, a manifold frame 22, an intake port 23, and an exhaust port 24. In the illustrated embodiment, each suction nozzle 21 includes a suction surface disposed flush with the clamping surface 11. Accordingly, the plurality of suction nozzles 21 and the clamping surface 11 collectively define a working surface for positioning an object, thereby enabling selective control over the adsorption or release of the object. The manifold frame 22 is configured as a rectangular frame corresponding in shape to the cross-shaped recess 13. In this embodiment, the manifold frame 22 is specifically formed as a cross-shaped frame 223 that is received within the cross-shaped recess 13.

The manifold frame 22 comprises the cross-shaped frame 223, a plurality of gas delivery conduits 221, and a distribution manifold 222. The cross-shaped frame 223 vertically protrudes with a plurality of conduit mounting bosses 224, which are spaced apart to facilitate the installation of the plurality of gas delivery conduits 221. The distribution manifold 222 is annularly arranged at the bottom of the cross-shaped frame 223. Furthermore, the cross-shaped frame 223 is penetrated by a plurality of flow ports 225, each of which communicates with the distribution manifold 222. Thus, when each gas delivery conduit 221 is installed between a pair of conduit mounting bosses 224, the gas delivery conduit 221 remains in fluid communication with the distribution manifold 222. Additionally, each distal end of the gas delivery conduits 221 forms one of the suction nozzles 21.

The intake port 23 and the exhaust port 24 are respectively mounted on the workpiece mounting platform 10. In the illustrated embodiment, the intake port 23 and the exhaust port 24 are disposed on the perimeter wall 12 of the workpiece mounting platform 10. Through the intake port 23 and the exhaust port 24, gas flows into and out of the modular vacuum assembly 20 via the plurality of gas delivery conduits 221 and the distribution manifold 222, thereby enabling the plurality of suction nozzles 21 to selectively operate in either a suction mode or a blowing mode.

The electromagnetic clamping assembly 30 is coupled to a lower surface of the workpiece mounting platform 10 and is configured to enable the clamping surface 11 to generate magnetic attraction through an electrification device 31. The electromagnetic clamping assembly 30 includes a base 32 and a magnetic field generator 33. The magnetic field generator 33 comprises a plurality of magnetic blocks arranged to correspond to the plurality of magnetic flux zones 14 of the workpiece mounting platform 10. Each of the magnetic flux zones 14 comprises two magnetic poles, namely a north (N) pole and a south (S) pole. By controlling an electrical input to the electrification device 31, the electromagnetic clamping assembly 30 generates magnetic attraction between the magnetic field generator 33 and the magnetic flux zones 14, thereby enabling a workpiece to be adsorbed onto and positioned on the clamping surface 11.

Through the above-described structural configuration, the hybrid magnetic-vacuum fixture is capable of integration with an automated control system to form an automated manufacturing system. When a non-metal workpiece is placed on the clamping surface 11, the modular vacuum assembly 20 generates vacuum suction via the plurality of gas delivery conduits 221, enabling the non-metal workpiece to be adsorbed and retained on the clamping surface 11. Conversely, the non-metal workpiece can be released by actuating a blowing mode at the plurality of suction nozzles 21.

When a metal workpiece is placed on the clamping surface 11, activation of the electrification device 31 causes the clamping surface 11 to generate magnetic attraction, thereby adsorbing and securing the metal workpiece in position. If the electrical power supplied to the electrification device 31 is subsequently reduced, the modular vacuum assembly 20 may maintain a negative pressure at the plurality of suction nozzles 21, thereby continuing to retain the metal workpiece in its positioned state.

Based on the foregoing description, the hybrid magnetic-vacuum fixture disclosed in the present invention provides the following functional advantages:
1. By integrating gas flow channels into a magnetic fixture architecture, the overall application range of the fixture is significantly broadened.
2. The modular vacuum assembly 20 incorporates a fully integrated internal flow channel system, which enables the modular vacuum assembly 20 not only to achieve workpiece retention via vacuum suction controlled electrically, but also to perform an “assisted release” function through pressurized air blowing, an operational mode not available in conventional magnetic clamping systems.
3. The hybrid magnetic-vacuum fixture is capable of positioning both metal and non-metal workpieces, thereby providing multimodal functionality that substantially improves its practical utility, operational flexibility, and overall usability in a wide range of industrial applications.

The embodiments described above are provided solely for the purpose of illustrating the structural and functional principles of the present invention. Although specific technical terms are employed in the foregoing disclosure, such usage is not intended to limit the scope of the invention. Those skilled in the art may, without departing from the spirit and underlying principles of the invention, make various modifications, substitutions, or equivalent alterations, all of which shall be deemed to fall within the scope defined by the appended claims.

What is claimed is:

1. A hybrid magnetic-vacuum fixture, comprising:
a workpiece mounting platform including a clamping surface;
a modular vacuum assembly assembled at a predetermined location on the workpiece mounting platform, wherein the modular vacuum assembly comprises a plurality of suction nozzles formed on the clamping surface, such that the plurality of suction nozzles and the clamping surface collectively define a working surface for positioning an object, thereby enabling selective control over the adsorption or release of the object; and
an electromagnetic clamping assembly assembled at another predetermined location on the workpiece mounting platform, wherein the electromagnetic clamping assembly is operatively coupled to an electrification device configured to generate magnetic attraction at the clamping surface.

2. The hybrid magnetic-vacuum fixture of claim 1, wherein the workpiece mounting platform defines a perimeter wall and comprises a cross-shaped recess and a magnetic flux zone.

3. The hybrid magnetic-vacuum fixture of claim 2, wherein the modular vacuum assembly comprises a manifold frame, an intake port, and an exhaust port, wherein the intake port and the exhaust port are respectively mounted on the perimeter wall of the workpiece mounting platform, and wherein the manifold frame is received within the cross-shaped recess of the workpiece mounting platform.

4. The hybrid magnetic-vacuum fixture of claim 3, wherein the manifold frame comprises a plurality of gas delivery conduits and a distribution manifold, wherein the plurality of gas delivery conduits are spaced apart from one another and are in fluid communication with the distribution manifold, and wherein each distal end of the gas delivery conduits defines one of the suction nozzles, such that gas flow through the intake port and the exhaust port enables the plurality of suction nozzles to selectively operate between suction and blowing modes.

5. The hybrid magnetic-vacuum fixture of claim 2, wherein the electromagnetic clamping assembly comprises a base having a magnetic field generator, wherein the magnetic field generator is configured to cooperate with the magnetic flux zone of the workpiece mounting platform through the electrification device to generate magnetic attraction at the clamping surface.

6. The hybrid magnetic-vacuum fixture of claim 1, wherein the object is made of a metal material or a non-metal material.

7. An automated manufacturing system, comprising:
an automated control device; and
a hybrid magnetic-vacuum fixture, comprising:
a workpiece mounting platform including a clamping surface;
a modular vacuum assembly assembled at a predetermined location on the workpiece mounting platform, wherein the modular vacuum assembly comprises a plurality of suction nozzles formed on the clamping surface, such that the plurality of suction nozzles and the clamping surface collectively define a working surface for positioning an object, thereby enabling selective control over the adsorption or release of the object; and
an electromagnetic clamping assembly assembled at another predetermined location on the workpiece mounting platform, wherein the electromagnetic clamping assembly is operatively coupled to an electrification device configured to generate magnetic attraction at the clamping surface;
wherein, when a metal object is placed on the clamping surface, the electromagnetic clamping assembly generates magnetic attraction to adsorb the metal object; and
wherein, when a non-metal object is placed on the clamping surface, the plurality of suction nozzles of the modular vacuum assembly generates vacuum suction to adsorb the non-metal object.

8. The automated manufacturing system of claim 7, wherein the workpiece mounting platform defines a perimeter wall and comprises a cross-shaped recess and a magnetic flux zone, wherein the modular vacuum assembly comprises a manifold frame, an intake port, and an exhaust port, wherein the intake port and the exhaust port are respectively mounted on the perimeter wall of the workpiece mounting platform, and wherein the manifold frame is received within the cross-shaped recess, the manifold frame comprising a plurality of gas delivery conduits and a distribution manifold, wherein the gas delivery conduits are spaced apart and are in fluid communication with the distribution manifold, and wherein each distal end of the gas delivery conduits defines one of the suction nozzles, such that gas flow through the intake port and the exhaust port enables the plurality of suction nozzles to selectively operate between suction and blowing modes.

9. The automated manufacturing system of claim 7, wherein the workpiece mounting platform defines a perimeter wall and comprises a cross-shaped recess and a magnetic flux zone, wherein the electromagnetic clamping assembly comprises a base having a magnetic field generator, and wherein the magnetic field generator cooperates with the magnetic flux zone of the workpiece mounting platform through the electrification device to generate magnetic attraction at the clamping surface.
